(19) United States
(12) Patent Application Publication
(10) Pub. No.: US 2025/0269470 A1
(43) Pub. Date: Aug. 28, 2025

(54) METHOD AND LASER SYSTEM FOR SEPARATING A WORKPIECE

(71) Applicant: TRUMPF Laser GmbH, Schramberg (DE)

(72) Inventors: Myriam KAISER, Heimsheim (DE); Svenja EDE, Bardowick (DE); Daniel FLAMM, Ludwigsburg (DE); Max KAHMANN, Nufringen (DE); Jonas KLEINER, Leonberg (DE)

(21) Appl. No.: 19/204,684

(22) Filed: May 12, 2025

Related U.S. Application Data
(63) Continuation of application No. PCT/EP2023/082270, filed on Nov. 17, 2023.

(30) Foreign Application Priority Data
Nov. 29, 2022 (DE) 10 2022 131 536.3

(51) Int. Cl. B23K 26/38; B23K 26/06; B23K 26/064; B23K 26/53

(52) U.S. Cl. CPC B23K 26/38; B23K 26/0608; B23K 26/064; B23K 26/53

(57) ABSTRACT

A method for separating a workpiece includes providing a machining laser beam that forms a plurality of focusing elements, introducing the focusing elements into a material of the workpiece, and moving the focusing elements parallel to an advancing line relative to the material. Material modifications are formed in the material along a machining surface that protrudes with respect to a partial region of the workpiece in a preferred direction. The method further includes subjecting the material to a heating laser beam that is moved relative to the material along a heating laser beam advancing line, thereby separating the material along the machining surface. The heating laser beam advancing line runs parallel to and is spaced apart from the advancing line with a positional offset that is anti-parallel to the preferred direction. The positional offset is at least 10% and at most 50% of a diameter of the heating laser beam.

### CROSS REFERENCE TO RELATED APPLICATIONS

This application is a continuation of International Application No. PCT/EP2023/082270 (WO 2024/115146 A1), filed on Nov. 17, 2023, and claims benefit to German Patent Application No. DE 10 2022 131 536.3, filed on Nov. 29, 2022. The aforementioned applications are hereby incorporated by reference herein.

### FIELD

Embodiments of the present invention relate to a method and a laser system for separating a workpiece.

### BACKGROUND

WO 2022/167254 A1 and WO 2022/167257 A1 each disclose methods and devices for laser machining of a transparent workpiece, wherein the workpiece is subjected to a plurality of focusing elements for laser machining.

JP 2020 004 889 A discloses a method for separating and in particular beveling a transparent material, wherein a spatial light modulator is used to produce a plurality of focal points for laser machining of the material.

US 2020/0147729 A1 and US 2020/0361037 A1 each disclose methods for forming a beveled or rounded edge region on a transparent material using a laser beam.

EP 3 597 353 A1, EP 3 487 656 B1 and WO 2016/089799 A1 disclose methods for separating a transparent material using non-diffracting laser beams.

### SUMMARY

Embodiments of the present invention provide a method for separating a workpiece. The method includes providing a pulsed machining laser beam. The machining laser beam forms a plurality of focusing elements. The workpiece comprises a material transparent to the machining laser beam. The method further includes introducing the focusing elements into the material of the workpiece, and moving the focusing elements parallel to a predetermined advancing line relative to the material. Material modifications, arranged by the moving the focusing elements relative to the material along a machining surface, are formed in the material. The machining surface protrudes with respect to a partial region of the workpiece in a preferred direction. The method further includes subjecting the material to a heating laser beam. The material of the workpiece is opaque to the heating laser beam. The heating laser beam is moved relative to the material along a heating laser beam advancing line, thereby separating the material along the machining surface. The heating laser beam advancing line runs parallel to the predetermined advancing line and is spaced apart from the predetermined advancing line with a positional offset that is anti-parallel to the preferred direction. The positional offset is at least 10% and at most 50% of a diameter of the heating laser beam.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an exemplary embodiment of a laser system for separating a workpiece;

FIG. 2 shows a schematic cross-sectional representation of a section of a material of the workpiece, in which the material is subjected to multiple focusing elements in order to form material modifications, wherein the focusing elements are arranged along a machining line which has different rectilinear sections, according to some embodiments;

FIG. 3 shows a schematic cross-sectional representation of a section of the workpiece, in which material modifications have been produced by subjecting the workpiece to focusing elements, which are accompanied by crack formation of the material, according to some embodiments;

FIG. 4a shows a cross-sectional representation of a simulated intensity distribution of focusing elements for laser machining of the workpiece, wherein adjacent focusing elements are each spaced apart at a distance of approx. 17.5 μm from one another, according to some embodiments;

FIG. 4b shows a cross-sectional representation of a simulated intensity distribution of focusing elements for laser machining of the workpiece, wherein adjacent focusing elements are each spaced apart at a distance of approx. 8.0 μm from one another, according to some embodiments;

FIG. 5a shows a schematic perspective view of a workpiece with material modifications formed thereon, which extend along a machining line and/or machining surface, according to some embodiments;

FIG. 5b shows a schematic perspective view of two workpiece segments formed by separating the workpiece according to FIG. 5a along the machining line and/or machining surface, according to some embodiments; and

FIG. 6 shows a schematic cross-sectional representation of a section of a material of the workpiece, in which the material is subjected to multiple focusing elements in order to form material modifications, wherein the focusing elements are positioned along an arcuate machining line, according to some embodiments.

### DETAILED DESCRIPTION

Embodiments of the present invention provide a method and a laser system which enable the material to be separated with a high degree of quality at the separating surface, wherein the separating surface has a predetermined geometry.

In the method according to embodiments of the invention, a pulsed machining laser beam is provided which forms a plurality of focusing elements, wherein the workpiece comprises a material transparent to the machining laser beam, the focusing elements are introduced into the material of the workpiece and are moved parallel to a predetermined advancing line relative to the material, wherein material modifications arranged by relative movement of the focusing elements, which are introduced into the material, along a machining surface are formed in the material, and wherein the machining surface protrudes with respect to a partial region of the workpiece in a preferred direction, and the material is subjected to a heating laser beam, wherein the material of the workpiece is opaque to the heating laser beam, wherein the heating laser beam is moved relative to the material along a heating laser beam advancing line, as a result of which the material is separated along the machining surface, wherein the heating laser beam advancing line runs parallel to the advancing line and is spaced apart from the advancing line with a positional offset which is anti-parallel to the preferred direction, and wherein the positional offset is at least 10% and at most 50% of a diameter of the heating laser beam.

It has been shown that the incidence of the heating laser beam with the aforementioned positional offset causes targeted crack formation between material modifications arranged on the machining surface. This crack formation then leads to a separation of the material with a separating surface that has a geometric shape corresponding to the machining surface. In addition, the separating surface is formed with an improved degree of quality, wherein the separating surface has a reduced roughness in particular.

In particular, the positional offset with which the heating laser beam advancing line is offset from the advancing line of the focusing elements can be at least 15% and in particular at least 20% and in particular at least 25% of the diameter of the heating laser beam. This results in the aforementioned advantages.

For the reasons mentioned above, it can be favorable if the machining laser beam and/or the heating laser beam are coupled through a first outer side of the workpiece into the material thereof, wherein a thickness direction of the workpiece is oriented transversely and in particular perpendicularly to the first outer side.

In particular, the machining laser beam and/or the heating laser beam are directed onto the first outer side for coupling into the material. In particular, the heating laser beam incident on the first outer side is divergent or collimated and in particular not focused and/or not convergent.

In particular, the workpiece is designed to be plate-shaped and/or sheet-shaped and/or disc-shaped. In particular, the workpiece has a first outer side and a second outer side spaced apart from the first outer side in the thickness direction of the workpiece, wherein the first outer side and the second outer side are oriented parallel or transverse to one another and/or wherein the first outer side and the second outer side are spaced apart from one another with a thickness and, in particular, constant thickness of the workpiece.

In particular, the first outer side is the outer side of the workpiece that is first subjected to the machining laser beam and/or the heating laser beam with respect to their respective beam propagation direction.

In particular, the machining laser beam is oriented perpendicular to the first outer side. In particular, the heating laser beam and in particular a longitudinal center axis of the heating laser beam is/are oriented perpendicular to the first outer side.

For the reasons mentioned above, it is advantageous if the partial region, with respect to which the machining surface protrudes in the preferred direction, is subjected to the heating laser beam. In particular, this ensures proper separation of the workpiece along the machining surface protruding in the preferred direction.

For the same reasons, it is favorable if the heating laser beam advancing line runs in the partial region, with respect to which the machining surface protrudes in the preferred direction.

In particular, the preferred direction can be oriented perpendicular to a plane which runs parallel to the advancing line and parallel to the thickness direction of the workpiece to be separated.

In particular, the thickness direction is oriented parallel to a beam propagation direction of the machining laser beam and/or the heating laser beam.

In particular, the preferred direction points from the interior of the partial region, with respect to which the machining surface protrudes in the preferred direction, in the direction of a bulge formed with respect to this partial region and/or a protrusion of the machining surface formed with respect to this partial region.

In particular, the machining surface can extend continuously between a first outer side and a second outer side of the workpiece spaced apart from the first outer side in the thickness direction. In particular, this makes it possible to achieve a continuous separation of the workpiece along the machining surface.

In particular, material modifications are arranged in the material on the machining surface, which allow for a continuous and/or uninterrupted separation of the material between the first outer side and the second outer side by means of the heating laser beam.

It can be advantageous if the heating laser beam has a diameter of at least 0.5 mm and at most 5 mm and in particular of at least 2 mm and at most 4 mm. This allows the workpiece to be separated with a high degree of quality at the separating surface. In particular, the diameter of the heating laser beam is to be understood as the diameter with which the heating laser beam impinges on the workpiece and/or which the heating laser beam has on a first outer side of the workpiece.

The positional offset anti-parallel to the preferred direction is between 200 μm and 1.5 mm, for example.

It can be favorable if the machining laser beam has a wavelength of at least 300 nm and at most 1500 nm. For example, the wavelength is 1030 nm or 515 nm. This allows for the focusing elements formed by the machining laser beam to be introduced into a variety of materials, such as glass materials and/or plastic materials, which are transparent to laser beams in this wavelength range or with these wavelengths.

In particular, the machining laser beam can have ultra-short laser pulses. This allows for material modifications to be formed in a technically simple manner using the focusing elements, which enable the material to be separated using the machining laser beam. For example, the pulse duration of the laser pulses is between 10 fs and 50 ns.

It can be advantageous if the heating laser beam has a wavelength of at least 9 μm and at most 11 μm. This allows for an effective separation of the workpiece by subjecting its material to the heating laser beam.

In particular, the heating laser beam can be a pulsed laser beam. However, it is also possible in principle for the heating laser beam to be a continuous wave laser beam.

The power of the heating laser beam is between 20 W and 35 W in particular.

In particular, a speed of advance at which the heating laser beam is moved along the heating laser beam advancing line is between 2 m/min and 3 m/min.

In particular, the workpiece to be separated can have a thickness between 10 μm and 10 mm and preferably between 100 μm and 1 mm and particularly preferably between 450 μm and 650 μm. Workpieces with thicknesses in the ranges mentioned can be separated using the method according to embodiments of the invention with a particularly good quality of the separating surface.

For the same reason, it can be advantageous if an extension length of the machining surface oriented parallel to the preferred direction has at least 5% and at most 70% and preferably at least 15% and at most 35% of a thickness of the workpiece to be separated. The extension length is between 25 μm and 400 μm, for example.

In particular, by separating the material of the workpiece along the machining surface, a workpiece segment corresponding to the partial region of the workpiece with respect to which the machining direction protrudes into the preferred direction is formed. This workpiece segment has a separating surface corresponding to the machining surface, wherein in particular a cross-sectional geometry of the machining surface corresponds to a cross-sectional geometry of the separating surface.

In particular, the focusing elements can be arranged, when viewed in a cross-section oriented perpendicularly to the advancing line and/or in a projection oriented perpendicularly to the advancing line, along a predetermined machining line, which defines a cross-sectional shape of the machining surface and/or a cross-sectional shape of a separating surface produced by separating the material along the machining surface.

An angle of attack between the machining line and a first outer side of the workpiece, through which the machining laser beam is coupled into the material of the workpiece in order to form the focusing elements, can be at least 1° and/or at most 90° and in particular at most 89° at least in sections. Depending on the angle of attack selected, a perpendicular cut can be made on the workpiece, for example, or the workpiece can be chamfered at a specific angle.

By the fact that the machining line has a specific angle of attack or angle of attack range at least in sections, it is to be understood in particular that the machining line has at least one section with this angle of attack or angle of attack range.

In particular, the angle of attack can be at least 10° and/or at most 80°, preferably at least 30° and/or at most 60°, particularly preferably at least 40° and/or at most 50°.

In particular, the angle of attack of the machining line can be constant at least in sections and/or the machining line can have multiple sections with different angles of attack.

In particular, the machining line can be a straight line at least in sections and/or the machining line can be a curve at least in sections.

By designing the machining line as a curve, for example, rounded segments can be cut off the workpiece. This allows rounded edges to be produced, for example.

If the machining line is designed as a curve, for example, the machining line is assigned a specific angle of attack range, which the machining line has in relation to the outer side of the workpiece.

For example, the at least one machining line has a total length of between 10 μm and 10000 μm and in particular between 100 μm and 1000 μm and in particular between 400 μm and 600 μm. This allows workpieces with a thickness in the range mentioned to be separated.

It can be advantageous if the focusing elements are formed by splitting an input laser beam into a plurality of sub-beams by means of a beam splitting element and by focusing the sub-beams coupled out from the beam splitting element. As a result, multiple focusing elements can be formed by means of the input laser beam, wherein in particular the properties of the focusing elements, such as their geometric shape and/or their intensity profile, are defined by the input laser beam and/or are based on the input laser beam.

It can be favorable if the splitting of the input laser beam by means of the beam splitting element is performed by a phase imposition on a beam cross-section of the input laser beam or comprises a phase imposition on a beam cross-section of the input laser beam. This allows the focusing elements to be formed as copies of one another, for example. In particular, this allows the focusing elements to be introduced into the workpiece material at different positions and/or at different distances in a technically simple manner.

The splitting of the input laser beam can be performed exclusively by phase imposition on the beam cross-section of the input laser beam.

In particular, the phase imposition is performed in the transverse direction of the input laser beam. The transverse direction lies in a plane oriented perpendicular to the beam propagation direction of the input laser beam.

Alternatively or additionally, the input laser beam can be split by means of the beam splitting element by polarization beam splitting or can comprise polarization beam splitting. Then, for example, focusing elements adjacent to one another can each be formed with different polarization states. In particular, this prevents interference between adjacent focusing elements, allowing them to be arranged at a particularly short distance from one another.

In principle, it is possible to split the input laser beam using both phase imposition and polarization beam splitting.

The material modifications introduced into transparent materials by ultra-short laser pulses are divided into three different classes, see K. Itoh et al. “Ultrafast Processes for Bulk Modification of Transparent Materials” MRS Bulletin, vol. 31 p. 620 (2006): Type I is an isotropic refractive index change, type II is a birefringent refractive index change and type III is a so-called “void” or cavity. The type of material modification produced by a specific focusing element depends on laser parameters of the laser beam from which the corresponding focusing element is formed, such as the pulse duration, the wavelength, the pulse energy and the repetition frequency of the laser beam. Furthermore, the type of modification depends on the properties of the material, such as the electronic structure and the thermal expansion coefficient of the material, as well as on the numerical aperture (NA) used when focusing the laser beam into the corresponding focusing element.

The isotropic refractive index changes of type I are attributed to localized melting by the laser pulses and rapid resolidification of the transparent material. For example, the density and refractive index of quartz glass is higher when the quartz glass is cooled down quickly from a higher temperature. So if the material in the volume acquired by the focusing element melts and then cools quickly, the quartz glass has a higher refractive index in the regions of material modification than in the unmodified regions.

The birefringent refractive index changes of type II can be caused, for example, by interference between an ultra-short laser pulse and the electric field of the plasma produced by the laser pulses. This interference leads to periodic modulations in the electron plasma density, which results in a birefringent property, i.e., direction-dependent refractive indices, of the transparent material during solidification. A type II modification is also associated with the formation of so-called “nanogratings”, for example.

The voids (cavities) of type III modifications can be produced in particular with a high laser pulse energy. In this regard, the formation of voids is attributed to an explosive expansion of highly excited, vaporized material from the focal volume into the surrounding material. This process is also known as a micro-explosion. As this expansion takes place within the bulk of the material, the micro-explosion leaves behind a less dense or hollow core (the void), or a microscopic defect in the sub-micrometer or atomic range, surrounded by a compacted shell of material. The compaction at the impact front of the micro-explosion creates stresses in the transparent material that regularly lead to spontaneous crack formation or promote crack formation.

Accordingly, whenever reference is made to the introduction of a type III modification, a less dense or hollow core or a defect is present. By way of example, in the case of a type III modification in sapphire, a region of lower density rather than a void is produced by the micro-explosion.

In particular, the formation of voids may also be accompanied by type I and type II modifications. For example, type I and type II modifications can occur in the less stressed areas around the introduced laser pulses. The formation of type I and type II modifications cannot be fully prevented or avoided when introducing type III modifications. It is therefore unlikely that “pure” type III modifications are to be found.

It can be advantageous if material modifications are formed in the material by subjecting the material of the workpiece to the focusing elements, wherein the material modifications are accompanied by a crack formation of the material, and/or wherein the material modifications are type III material modifications. In particular, a separation of the material can be implemented by means of these material modifications.

According to embodiments of the invention, a laser system is provided for separating a workpiece, comprising a laser beam source, a beam splitting element and a focusing optical unit, which together are designed to provide a machining laser beam which forms a plurality of focusing elements for introduction into a material of the workpiece, an advancing device for carrying out a relative movement of the focusing elements with respect to the material of the workpiece parallel to a predetermined advancing line in order to form material modifications arranged in the material along a machining surface, wherein it is provided that the machining surface protrudes with respect to a partial region of the workpiece in a preferred direction, a further laser beam source for providing a heating laser beam, wherein the advancing device is designed to move the heating laser beam along a heating laser beam advancing line relative to the material in order to separate the material along the machining surface, wherein the heating laser beam advancing line runs parallel to the advancing line and is spaced apart from the advancing line with a positional offset which is anti-parallel to the preferred direction, and wherein the positional offset is at least 10% and at most 50% of a diameter of the heating laser beam.

In particular, the laser system according to embodiments of the invention has one or more further features and/or advantages of the method according to embodiments of the invention. Advantageous embodiments of the laser system according to embodiments of the invention have already been explained in connection with the method according to embodiments of the invention.

In particular, the method according to embodiments of the invention can be carried out by means of the laser system according to embodiments of the invention or the method according to embodiments of the invention is carried out by means of the laser system according to embodiments of the invention.

In particular, the laser system according to embodiments of the invention is suitable for separating a workpiece which has a material that is transparent to the machining laser beam and/or a material that is opaque to the heating laser beam.

It can be advantageous if the beam splitting element is designed as a 3D beam splitting element or comprises a 3D beam splitting element. The input laser beam can then be split by means of phase imposition on a beam cross-section of the input laser beam and, in particular, exclusively by means of phase imposition on the beam cross-section of the input laser beam.

It can be advantageous if the beam splitting element is designed as a polarization beam splitting element or comprises a polarization beam splitting element.

For example, the beam splitting element comprises multiple components and/or functionalities. The beam splitting element can comprise both a 3D beam splitting element and a polarization beam splitting element.

A transparent material is understood to be a material through which at least 70% and in particular at least 80% and in particular at least 90% of the laser energy of the machining laser beam is transmitted. If, for example, the machining laser beam is directed onto a first outer side of the workpiece, at least 70% and in particular at least 80% and in particular at least 90% of the laser energy of the machining laser beam is transmitted to a second outer side of the workpiece that is spaced apart from the first outer side in the beam propagation direction and/or thickness direction.

An opaque and/or non-transparent material is understood to be a material through which at most 10% and in particular at most 5% and in particular at most 3% of a laser energy of the heating laser beam is transmitted. If, for example, the heating laser beam is directed onto a first outer side of the workpiece, at most 10% and in particular at most 5% and in particular at most 3% of the laser energy of the machining laser beam is transmitted to a second outer side of the workpiece that is spaced apart from the first outer side in the beam propagation direction and/or thickness direction.

In particular, a focusing element is understood to be a radiation area with a specific spatial extent and intensity distribution. In order to determine the spatial dimensions of a specific focusing element, such as the diameter of the focusing element, only intensity values of the intensity distribution that lie above a specific intensity threshold are considered. In this regard, the intensity threshold is selected, for example, such that values below this intensity threshold have such a low intensity that they are no longer relevant for interaction with the material for the purpose of forming material modifications. For example, the intensity threshold is 50% of a global intensity maximum of the focusing element.

In particular, a spatial interaction region is assigned to a specific focusing element, in which the focusing element interacts with the material of the workpiece when it is introduced into it.

In particular, the focusing elements introduced into the material interact with the material by non-linear absorption. In particular, the focusing elements are used to form material modifications in the material due to non-linear absorption.

In particular, the respective focusing elements according to the preceding definition can have a maximum spatial extent of at least 0.5 μm and/or at most 30 μm, preferably at least 2 μm and/or at most 10 μm. In particular, a maximum spatial extent of an interaction region assigned to a specific focusing element with the material of the workpiece is at least 0.5 μm and/or at most 30 μm, and preferably at least 2 μm and/or at most 10 μm.

The maximum spatial extent of a specific focusing element is to be understood in particular as the largest spatial extent of the focusing element in any spatial direction.

In particular, a respective maximum spatial extent of the focusing elements is less than 20% and preferably less than 10% and particularly preferably less than 5% of a thickness of the material.

In particular, the focusing elements have a diffracting beam profile. In particular, the focusing elements are designed as diffraction-limited. For example, a specific focusing element has a Gaussian shape and/or a Gaussian intensity profile. However, it is also possible for the focusing elements to have a non-diffracting and in particular a Bessel-like beam profile.

In particular, the machining laser beam has a diffracting beam profile and/or a Gaussian beam profile.

In particular, adjacent focusing elements have a distance of at least 3 μm and/or at most 70 μm from one another, wherein a distance direction assigned to this distance is oriented perpendicular to the advancing line of the focusing elements and/or to the advancing direction.

In particular, adjacent material modifications, which are arranged on the machining surface, have a distance of between 3 μm and 70 μm from one another, wherein a distance direction assigned to this distance is oriented perpendicular to the advancing line and/or to the advancing direction of the focusing elements.

In particular, adjacent material modifications, which are arranged on the machining surface, have a distance of between 1 μm and 30 μm from one another, wherein a distance direction assigned to this distance is oriented parallel to the advancing line and/or the advancing direction of the focusing elements.

In particular, adjacent material modifications, which are arranged on the machining surface, have such a distance from one another that crack formation occurs between adjacent material modifications and/or that separation of the material on the machining surface is made possible by means of the heating laser beam.

In particular, the machining laser beam has a mean power of at least 1 W to 1 kW. For example, the machining laser beam comprises pulses with a pulse energy of at least 10 μJ and/or at most 50 mJ. The machining laser beam can comprise individual pulses or bursts, wherein the bursts have 2 to 20 sub-pulses and, in particular, a time interval of approximately 20 ns.

The term “at least a subset of the focusing elements” can mean either a subset of the focusing elements or a total set of the focusing elements, i.e., all focusing elements.

In particular, the terms “at least approximately” or “approximately” are generally understood to mean a deviation of no more than 10%. Unless otherwise specified, the terms “at least approximately” or “approximately” are to be understood in particular to mean that an actual value and/or distance and/or angle deviates by no more than 10% from an ideal value and/or distance and/or angle.

Elements that are the same or have equivalent functions are provided with the same reference signs in all of the figures. The figures shown are not to scale.

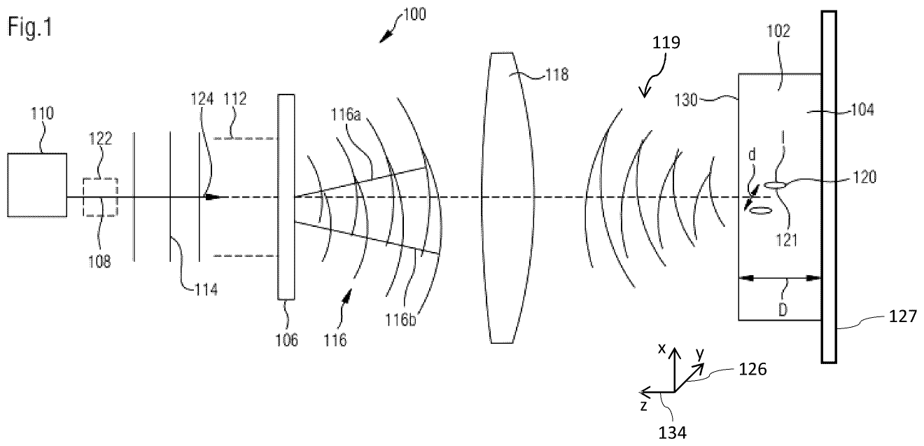

An exemplary embodiment of a laser system for separating a workpiece is shown in FIG. 1, where it is designated with 100. The laser system 100 can be used to produce localized material modifications in a material 102 of the workpiece 104, such as defects in the sub-micrometer or atomic range, which result in a weakening of the material. The workpiece 104 can be separated at these material modifications, wherein, for example, the workpiece 104 can be divided into two workpiece segments or a workpiece segment can be separated from the workpiece 104.

In particular, the laser system 100 can be used to introduce material modifications into the material 102 at an angle of attack such that an edge region of the workpiece 104 can be chamfered or beveled by separating a workpiece segment from the workpiece 104.

The laser system 100 comprises a beam splitting element 106 into which an input laser beam 108, in particular a collimated input laser beam, is coupled. This input laser beam 108 is provided by means of a laser beam source 110 of the laser system 100. In particular, the input laser beam 108 is a pulsed laser beam and/or an ultra-short pulse laser beam.

The laser beam source 110 can comprise a hollow core fiber (not shown) from which a laser beam formed by means of the laser beam source 110 emerges. This laser beam is then collimated, for example, using collimating optics (not shown) of the laser beam source 110 in order to form the input laser beam 108.

The input laser beam 108 is to be understood to mean a beam bundle comprising a plurality of beams extending in particular in parallel. The input laser beam 108 has a transverse beam cross-section 112 and/or a transverse beam expansion, with which the input laser beam 108 impinges on the beam splitting element 106.

In particular, the input laser beam 108 impinging on the beam splitting element 106 has at least approximately planar wavefronts 114.

By means of the beam splitting element 106, the input laser beam 108 is split into a plurality of sub-beams 116 or sub-beam bundles. In the example shown in FIG. 1, two different sub-beams 116a and 116b or sub-beam bundles are indicated.

In particular, the beam splitting element 106 is designed as a far-field beam forming element. In particular, the sub-beam bundles coupled out of the beam splitting element 106 have a divergent beam profile and/or propagate in the manner of spherical waves.

In order to focus the sub-beams 116 coupled out of the beam splitting element 106, the laser system 100 comprises a focusing optical unit 118 into which the sub-beams 116 are coupled. For example, the focusing optical unit 118 has one or more lens elements. For example, the focusing optical unit 118 is designed as a microscope objective.

For example, the focusing optical unit 118 has a focal length of between 5 mm and 50 mm.

In particular, the beam splitting element 106 is arranged at least approximately in a rear focal plane of the focusing optical unit 118.

In particular, different sub-beams 116 impinge on the focusing optical unit 118 with a positional offset and/or angular offset. These sub-beams 116 are focused by means of the focusing optical unit 118, wherein a sum of the sub-beams 116 focused by means of the focusing optical unit 118 is referred to as the machining laser beam 119. By focusing the sub-beams, multiple focusing elements 120 are formed, which are each arranged at different spatial positions. In principle, it is possible for mutually adjacent focusing elements 120 to overlap spatially in sections.

The machining laser beam 119 is thus to be understood as the sub-beams emerging from the machining optics 118, which form the focusing elements 120.

In particular, multiple sub-beams 116 are, in each case, assigned to a specific focusing element 120, i.e., a specific focusing element 120 is formed from multiple sub-beams 116 impinging on the focusing optical unit 118.

In particular, a focusing element 120 is to be understood as a focused radiation area, such as a focus spot and/or a focal point. In particular, the focusing elements 120 each have a specific geometric shape and/or a specific intensity profile, wherein the geometric shape is to be understood, for example, as a spatial shape and/or spatial extent of the respective focusing element 120.

The geometric shape and/or intensity profile of a specific focusing element 120 is hereinafter referred to as the focus distribution 121 of the focusing element 120. The focus distribution 121 is a property of the respective focusing elements 120 and describes their respective shape and/or intensity profile. In particular, multiple focusing elements 120 or all formed focusing elements 120 have the same focus distribution.

The focus distribution of the formed focusing elements 120 is defined by the input laser beam 108, the splitting of which using the beam splitting element 106 forms the focusing elements 120. If the input laser beam 108 were focused before being coupled into the beam splitting element 106, a single focusing element would be formed with the focus distribution associated with the input laser beam 108.

For example, the input laser beam 108 can have a Gaussian beam profile. In this case, by focusing the input laser beam 108, a focusing element would be formed that has a focus distribution 121 with a Gaussian shape and/or Gaussian intensity profile.

Alternatively, for example, the input laser beam 108 can be assigned a Bessel-like beam profile so that by focusing the input laser beam 108, a focusing element would be formed which has a focus distribution 121 with a Bessel-like shape and/or Bessel-like intensity profile.

The sub-beams 116 or sub-beam bundles formed by splitting the input laser beam 108 by means of the beam splitting element 106 are assigned the focus distribution of the input laser beam 108 in such a way that, by focusing the sub-beams 116, the focusing elements 120 are formed with this focus distribution and/or with a focus distribution based on this focus distribution.

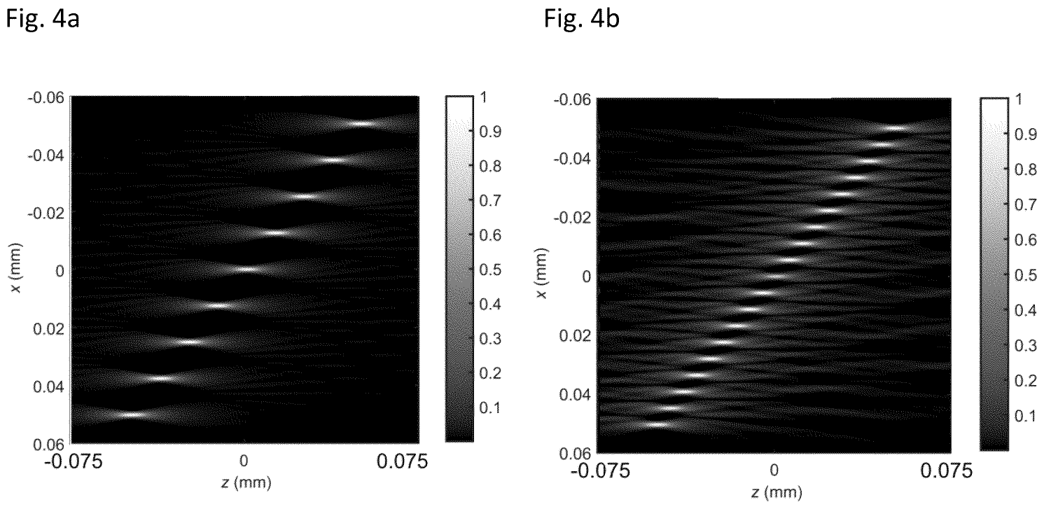

In the example shown in FIG. 1, the input laser beam 108 has a Gaussian beam profile, i.e., the input laser beam 108 is assigned a focus distribution with a Gaussian shape and/or a Gaussian intensity profile. The focusing elements 120 then, for example, each have the focus distribution 121 with this Gaussian shape and/or this Gaussian intensity profile or with a shape and/or intensity profile based on this Gaussian shape and/or this Gaussian intensity profile (see also FIGS. 4a and 4b).

For example, if the input laser beam 108 is assigned a Bessel-like beam profile, the focusing elements 120 formed for laser machining the workpiece 104 each have a focus distribution 121 with this Bessel-like beam profile or with a beam profile based on this Bessel-like profile. As a result, the focusing elements 120 can each be formed, for example, with a focus distribution that has an elongated shape and/or an elongated intensity profile.

The laser system 100 can have a beam forming device 122 for forming the input laser beam 108 (indicated in FIG. 1). For example, this beam forming device 122 is arranged in front of the beam splitting element 106 with respect to a beam propagation direction 124 of the input laser beam 108 and/or arranged between the laser beam source 110 and the beam splitting element 106.

In the present case, the beam propagation direction is to be understood as a main beam propagation direction and/or a mean propagation direction of a laser beam or beam bundle. The beam propagation direction corresponds in particular to a direction of a Poynting vector assigned to the laser beam or beam bundle.

By means of the beam forming device 122, a specific beam profile can be assigned to the input laser beam 108, which defines the focus distribution 121 of the focusing elements 120.

For example, the beam forming device 122 can be designed to form a laser beam with a quasi-non-diffracting and/or Bessel-like beam profile from a laser beam with a Gaussian beam profile. To this end, the beam forming device 122 is or comprises, for example, a diffracting optical element and/or axicon element and/or axicon-like element.

The input laser beam 108 coupled into the beam splitting element 106 then has the quasi-non-diffracting or Bessel-like beam profile. Accordingly, the focusing elements 120 then also have this quasi-non-diffracting or Bessel-like beam profile or a beam profile based on this beam profile.

With regard to the definition and implementation of quasi-non-diffracting and/or Bessel-like beams, reference is made to the publication “Structured Light Fields: Applications in Optical Trapping, Manipulation and Organisation”, M. Wördemann, Springer Science & Business Media (2012), ISBN 978-3-642-29322-1 and also to the scientific publications “Bessel-like optical beams with arbitrary trajectories” by I Chremmos et al., Optics Letters, Vol. 37, No. 23, 1 Dec. 2012 and “Generalized axicon-based generation of nondiffracting beams” by K. Chen et al., arXiv: 1911.03103v1 [physics.optics], Nov. 8, 2019.

By means of beam splitting using the beam splitting element 106, the focusing elements 120 are in particular each formed identically to one another and/or each formed as copies of one another.

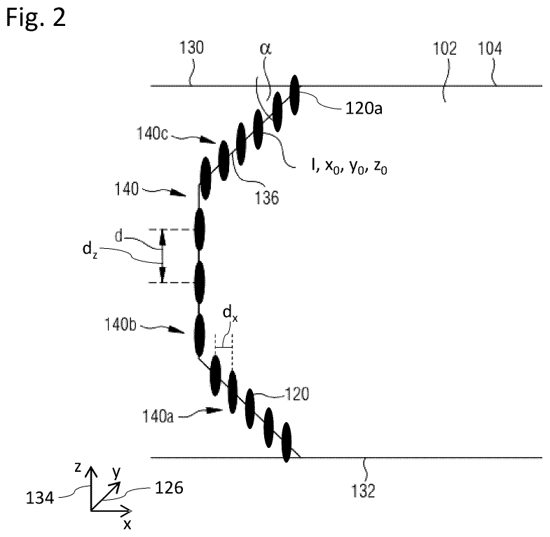

Each of the focusing elements 120 formed is assigned a specific local position x₀, y₀, z₀, at which a respective focusing element 120 is arranged with respect to the material 102 of the workpiece 104 (FIG. 2). In particular, the local position of a focusing element 120 is to be understood as the position of its spatial center and/or center of gravity. Furthermore, each of the formed focusing elements 120 is assigned a specific intensity I. The beam splitting element 106 can thus be used to define the local position x₀, y₀, z₀ and the intensity I of the respective focusing elements 120.

In particular, multiple or all of the focusing elements 120 formed for laser machining of the workpiece 104 have the same intensity I. However, it is also possible that several of the formed focusing elements 120 have different intensities I.

In particular, a respective distance d and/or a respective positional offset between focusing elements 120 adjacent to one another can be adjusted component by component in three spatial directions and/or spatial dimensions by means of the beam splitting element 106 (in the example shown in FIGS. 1 and 2 in the x, y and z-directions).

The distance d between adjacent focusing elements 120 is, for example, between 3 μm and 70 μm.

Preferably, the beam splitting element 106 is designed as a 3D beam splitting element or comprises a 3D beam splitting element. The focusing elements 120 can thus be formed, for example, in such a way that they are each identical to one another and/or that they are each copies of one another.

With respect to the technical implementation and properties of the beam splitting element 106 designed as a 3D beam splitting element, reference is made to the scientific publication “Structured light for ultrafast laser micro- and nanoprocessing” by D. Flamm et al., arXiv: 2012.10119v1 [physics.optics], Dec. 18, 2020. Full explicit reference is made thereto.

In order to perform the beam splitting, in one embodiment of the beam splitting element 106, in which the beam splitting element 106 is designed as a 3D beam splitting element, for example, a defined transverse phase distribution is imposed on the transverse beam cross-section 112 of the input laser beam 108. A transverse beam cross-section or a transverse phase distribution is to be understood in particular as a beam cross-section or a phase distribution in a plane oriented transversely and in particular perpendicularly to the beam propagation direction 124 of the input laser beam 108.

The focusing elements 120 are formed by interference of the focused sub-beams 116, wherein, for example, constructive interference, destructive interference or intermediate cases thereof can occur, such as partially constructive or partially destructive interference.

In order to form the focusing elements 120 at the respective position x₀, y₀, z₀ and/or with the respective distance d, the phase distribution imposed by means of the beam splitting element 106 has a specific optical grating component and/or optical lens component for each focusing element 120.

Due to the optical grating component, a corresponding positional offset of the formed focusing elements 120 in a first spatial direction and/or second spatial direction, such as in the x and/or y-direction, results after focusing of the sub-beams 116. Due to the optical lens component, the sub-beams 116 or sub-beam bundles impinge at different angles or different convergence or divergence on the focusing optical unit 118, which results in a positional offset in a third spatial direction, such as in the z-direction, after focusing has taken place.

The intensity I of the respective focusing elements 120 is determined by the phase positions of the focused sub-beams 116 relative to one another. These phase positions can be defined by the aforementioned optical grating components and optical lens components and can be selected in relation to one another when designing the beam splitting element 106 such that the focusing elements 120 each have a desired intensity.

Alternatively or additionally, the beam splitting element 106 can be designed as a polarization beam splitting element or can comprise a polarization beam splitting element. In this case, the beam splitting element 106 is used to perform a polarization beam splitting of the input laser beam 108 into beams, each of which has one of at least two different polarization states.

In particular, the polarization states mentioned are to be understood as linear polarization states, wherein, for example, two different polarization states are provided and/or polarization states oriented perpendicular to one another are provided.

In particular, the polarization states are such that an electric field is oriented in a plane perpendicular to the beam propagation direction of the polarized beams (transverse electric).

For polarization beam splitting, the beam splitting element 106 comprises, for example, a birefringent lens element and/or a birefringent wedge element. The birefringent lens element and/or the birefringent wedge element are made of a quartz crystal, for example, or comprise a quartz crystal.

Reference is made to DE 10 2020 207 715 A1 and DE 10 2019 217 577 A1 with regard to the mode of operation and design of the beam splitting element 106 as a polarization beam splitting element.

Polarization beam splitting allows the sub-beams 116 in particular to be formed with different polarization states. By focusing these sub-beams 116 by means of the focusing optical unit 118, the focusing elements 120 can each be formed from beams with a specific polarization state. The focusing elements 120 can thus each be assigned a specific polarization state and/or can be formed with a specific polarization state.

In particular, polarization beam splitting by means of the beam splitting element 106 allows the focusing elements 120 to be arranged and formed in such a way that focusing elements 120 adjacent to one another each have different polarization states.

For the laser machining of the workpiece 104, the focusing elements 120 are introduced into the material 102 of the workpiece 104 and moved relative to the material 102 in the advancing direction 126, wherein the focusing elements 120 are moved in particular at a specific speed of advance in the advancing direction 126. In the example shown, the advancing direction 126 corresponds to the y-direction.

In order to perform a relative movement of the focusing elements 120 to the material 102, the laser system 100 comprises an advancing device 127 (indicated in FIG. 1). The advancing device 127 is designed to move the focusing elements 120 in the advancing direction 126 through the material 102 at a defined speed of advance.

For example, the advancing device 127 can be implemented by means of a workpiece holder, which is designed to move the workpiece 104 arranged thereon with respect to the focusing elements 120. In principle, it is also possible for the focusing elements 120 to be moved with respect to the material 102. For this purpose, for example, the laser system 100 or parts of the laser system 100 are moved with respect to the material 102.

The focusing elements 120, which are introduced into the material 102 for laser machining of the workpiece 104, are coupled through a first outer side 130 of the workpiece 104, for example.

For example, the workpiece 104 is designed to be plate-shaped and/or sheet-shaped and/or disc-shaped. For example, a second outer side 132 of the workpiece 104 is arranged spaced apart from the first outer side 130 in the thickness direction 134 and/or depth direction of the workpiece 104. The second outer side 132 is oriented parallel or transverse to the first outer side 130.

The material 102 of the workpiece 104 has, for example, an at least approximately constant thickness D with respect to the thickness direction 134, wherein the thickness D is, for example, 550 μm.

The thickness direction 134 is to be understood as a distance direction between the first outer side 130 and the second outer side 132.

The advancing direction 126 is oriented transversely and, in particular, perpendicular to the beam propagation direction 124 and/or the thickness direction 134 of the workpiece 104.

The formed focusing elements 120 are arranged such that they are positioned along a defined machining line 136 (see FIG. 2), wherein the machining line 136 lies in a plane oriented perpendicular to the advancing direction 126. The machining line 136 corresponds to a target geometry with which a separation of the material 102 is to be performed.

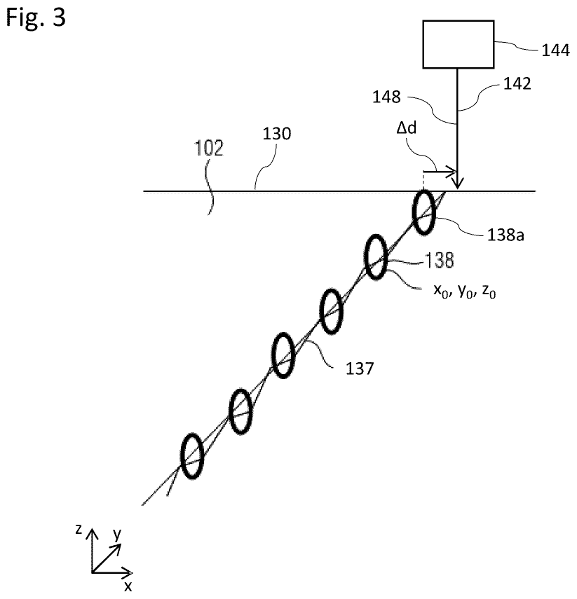

The respective distances d and intensities I of the focusing elements 120 arranged along the machining line 136 are selected such that material modifications 138 are formed by subjecting the material 102 to the focusing elements 120 or a movement of the focusing elements 120 through the material 102 (FIG. 3), which allow for the separation of the material along this machining line 136 or along a machining surface corresponding to this machining line 136.

In FIGS. 2 and 3, the focusing elements 120 and the material modifications 138 are each shown in a cross-section through the workpiece 104 oriented perpendicular to the advancing direction 126.

It is provided that the machining line 136 extends continuously and/or in an uninterrupted manner between the first outer side 130 and the second outer side 132. Continuous and/or uninterrupted focusing elements 120 are arranged along the machining line 136 in order to produce material modifications 138 arranged along the machining line 136, which allow for a continuous separation of the material 102 between the first outer side 130 and the second outer side 132.

The machining line 136 can have multiple different sections 140. For example, in the example shown in FIG. 2, the machining line 136 has a first section 140a, a second section 140b and a third section 140c, wherein, with respect to the thickness direction 134, the second section 140b adjoins the first section 140a and the third section 140c adjoins the second section 140b.

The machining line 136 is not necessarily designed as continuous and/or differentiable. For example, the machining line 136 can have discontinuities.

The machining line 136 and/or different sections 140 of the machining line 136 can be formed as a straight line or curve, for example. For example, the machining line can be formed as arcuate or in a circular arc.

The respective distance d of the focusing elements 120 provided for laser machining of the workpiece 104 can be selected differently for different focusing elements 120 and/or different pairs of focusing elements 120. However, it is also possible in principle that the respective distance d is at least approximately identical for all focusing elements 120 provided for laser machining of the workpiece 104.

For example, different sections 140 of the machining line 136 can each be assigned focusing elements 120 with different distances d. In particular, the respective distances d of the focusing elements 120 assigned to a specific section 140 are then at least approximately identical.

In particular, a distance component d_{z} of the distance d oriented parallel to the thickness direction 134 of the material 102 and/or perpendicular to the advancing direction 126 is different from zero for all focusing elements 120 and/or for all pairs of focusing elements 120 adjacent to one another. In particular, all adjacent focusing elements 120 are spaced apart with an effective distance component d_{z} in the thickness direction 134 that is different from zero.

Furthermore, the machining line 136 and/or the respective sections 140 of the machining line 136 are assigned a specific angle of attack α and/or angle of attack range, which the machining line 136 and/or the respective section 140 forms with the first outer side 130 of the workpiece 104.

In the case of an angle of attack between 1° and 89°, the focusing elements 120 adjacent to one another each have a further distance component dₓ of the distance d which is different from zero and which is oriented perpendicular to the advancing direction 126 and perpendicular to the distance component d_{z}.

The distance component d_{z} and the distance component dₓ each lie in a plane oriented perpendicular to the advancing direction 126.

In the exemplary embodiment shown, the angle of attack α of the first section 140a and the third section 140c is 45° in terms of absolute value and that of the second section 140b is 90°.

The focusing elements 120 formed for laser machining of the workpiece 104 can all lie in a plane which is oriented perpendicular to the advancing direction 126. In the situation shown in FIG. 2, for example, the local position z₀ would then be the same for all focusing elements 120 at a specific point in time with respect to the z-direction.

However, it is also possible in principle for at least a subset of the formed focusing elements to be positioned spaced apart in parallel to the advancing direction 126. In the situation shown in FIG. 2, for example, there would then be focusing elements 120, the local position z₀ of which is different with respect to the z-direction. In this case, the machining line 136 or the arrangement of the focusing elements 120 along the machining line 136 is defined by viewing the focusing elements 120 in a projection plane oriented perpendicular to the advancing direction 126.

In particular, all focusing elements 120 formed for laser machining of the workpiece 104 are present simultaneously at a specific point in time and, in particular, are not formed sequentially in time.

By subjecting and/or introducing the focusing elements 120 into the material 102, localized material modifications 138 are formed in each case, which are arranged at the respective local positions x₀, y₀, z₀ of the corresponding focusing elements 120 in the material 102 (FIG. 3). By appropriately selecting the machining parameters, such as the respective distances d between the focusing elements 120, their respective intensities I, the speed of advance oriented in the advancing direction 126 and the laser parameters of the input laser beam 108, the material modifications 138 can be formed, for example, as type III modifications, which are accompanied by a spontaneous formation of cracks 137 in the material 102 of the workpiece 104. In particular, cracks 137 are formed between mutually adjacent material modifications 138.

Alternatively, it is also possible to form the material modifications 138 as type I and/or type II modifications, which are accompanied by a heat accumulation in the material 102 and/or by a change in a refractive index of the material 102, by appropriately selecting the machining parameters. The formation of the material modifications 138 as type I and/or type II modifications is associated with a heat accumulation in the material 102 of the workpiece 104. In particular, in order to form these material modifications 138, the respective distance d between the focusing elements 120 is selected to be so small that this heat accumulation occurs when the material 102 is subjected to the focusing elements 120.

FIG. 4a shows a simulated intensity distribution of a plurality of focusing elements 120, wherein the distance d for these focusing elements 120 is approximately 17.5 μm. In the grayscale value representation shown, lighter areas represent higher intensities.

FIG. 4b shows a simulated intensity distribution of a plurality of focusing elements 120, wherein the distance d is approximately 8.0 μm.

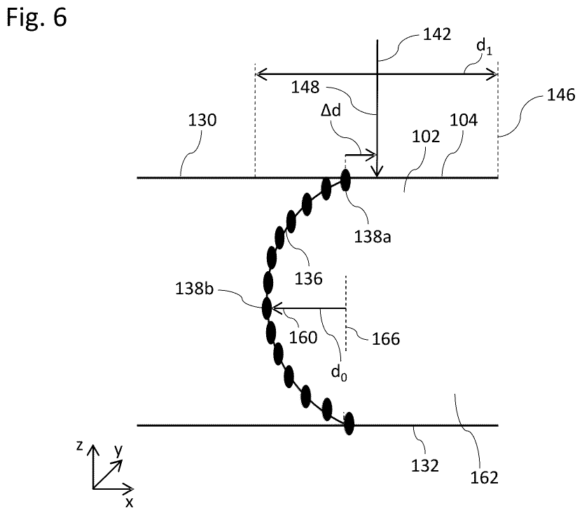

Once the material modifications 138 have been formed, the material 102 is subjected to a heating laser beam 142 in order to separate it (see FIGS. 3 and 6). In order to provide the heating laser beam 142, the laser system 100 comprises a further laser beam source 144, which is designed as a CO₂ laser, for example, or comprises a CO₂ laser.

For example, a wavelength of the heating laser beam 142 is between 9 μm and 11 μm. For example, the wavelength is 10.6 μm. The power of the heating laser beam 142 is then between 20 W and 35 W, for example.

In particular, the heating laser beam 142 is a pulsed laser beam, wherein a frequency is between 10 kHz and 15 kHz, for example 12.5 kHz. In principle, it is also possible for the heating laser beam 142 to be a continuous wave laser beam (cw laser beam).

The heating laser beam 142 is to be understood as a beam bundle comprising a plurality of beams. The heating laser beam 142 has a transverse beam cross-section 146 and/or a transverse beam expansion, with which it impinges on the first outer side 130 of the workpiece 104.

In particular, the heating laser beam 142 impinging on the first outer side 130 is divergent or collimated.

A longitudinal center axis 148 of the heating laser beam 142 is preferably oriented perpendicular to the first outer side 130. The longitudinal center axis 148 is to be understood in particular as a beam axis and/or symmetry axis of the heating laser beam in the beam propagation direction. The longitudinal center axis 148 is oriented parallel to the beam propagation direction of the heating laser beam 142.

A diameter d₁ (indicated in FIG. 6) of the heating laser beam 142 is preferably between 2 mm and 4 mm. For example, the diameter d₁ is 2.7 mm. In this regard, the diameter d₁ of the heating laser beam 142 is defined using the second moment method according to ISO 11146-3.

The longitudinal center axis 148 of the heating laser beam 142 has a positional offset Δd relative to a material modification 138a closest to the first outer side 130, which is oriented parallel to the first outer side 130 and/or perpendicular to the advancing direction 126. In the examples shown in FIGS. 3 and 6, the positional offset Δd is oriented parallel to the x-direction.

The laser machining of the workpiece 104 using the laser system 100 functions as follows:

In order to perform the laser machining, the material 102 of the workpiece 104 is subjected to the focusing elements 120 and the focusing elements 120 are moved in the advancing direction 126 relative to the workpiece 104 through its material 102.

In this context, the material 102 is a material, such as a glass material, which is transparent for a wavelength of laser beams, from which the focusing elements 120 are formed in each case. In the example shown, the focusing elements 120 are formed by beam forming of the input laser beam 108.

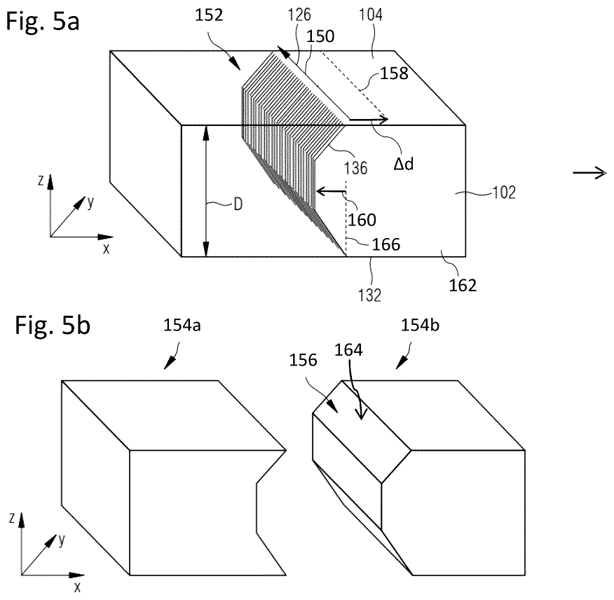

By subjecting the material 102 to the focusing elements 120, material modifications 138 are formed in the material 102, which are arranged in a cross-section oriented perpendicular to the advancing direction 126 along the machining line 136 (FIG. 5a). For example, as shown in FIG. 5a, material modifications 138 are formed continuously over the entire thickness D of the material 102.

By relative movement of the focusing elements 120 in relation to the material 102 along a predetermined advancing line 150, a machining surface 152 corresponding to the machining line 136 is formed, on which the material modifications 138 are arranged. This results in a planar formation and/or arrangement of the material modifications 138 along the machining surface 152.

The advancing line 150 is defined by the movement of a focusing element 120a closest to the first outer side 130 relative to the material 102 (see FIG. 2) and corresponds to the trajectory of this focusing element 120a relative to the material 102. By the fact that focusing elements 120 are moved along the advancing line 150, it is to be understood that each focusing element 120 is moved along a trajectory parallel to the advancing line 150 (and the focusing element 120a is moved along a trajectory identical to the advancing line 150). The advancing line 150 is thus to be understood as a reference line and/or reference trajectory for all focusing elements 120.

The advancing direction 126 is always oriented tangentially to the advancing line 150. This is not necessarily constant, as shown in FIG. 5a, for example, but can vary in principle. The advancing line 150 can thus, in principle, have straight and curved sections. In the case of curved sections, the advancing direction 126 is varied during laser machining and the machining line 136 is rotated so that it always lies in a plane oriented perpendicular to the advancing direction 126. This can be realized, for example, by rotating the beam splitting element 106 accordingly or by rotating parts of the laser system 100 relative to the workpiece 104.

A distance between adjacent material modifications 138 in the advancing direction 126 can be defined, for example, by adjusting a pulse duration of the input laser beam 108 and/or by adjusting the speed of advance.

In particular, the material modifications 138 formed along the machining surface 152 result in a reduction of a strength of the material 102. This allows the material 102 to be separated into two different workpiece segments 154a, 154b after the material modifications 136 have been formed on the machining surface 152 (FIG. 5b).

In the example shown, the workpiece segment 154b is a yield segment with a separating surface 156 having a shape corresponding to the shape of the machining line 136. In this case, the workpiece segment 154a is a residual workpiece segment and/or a scrap segment.

The workpiece 104 is separated by means of the heating laser beam 142 after the material modifications 138 arranged on the machining surface 152 have been formed. For this purpose, the heating laser beam 142 is directed onto the first outer side 130 and moved relative to the workpiece 104 along a heating laser beam advancing line 158, which is oriented parallel to the advancing line 150 along which the focusing elements 120 were previously moved relative to the workpiece 104. The heating laser beam advancing line 158 runs at a distance from the advancing line 150 with the positional offset Δd.

The relative movement of the heating laser beam 142 in relation to the material 102 of the workpiece 104 is realized, for example, by means of the advancing device 127, which can be designed accordingly for this purpose.

The heating laser beam advancing line 158 corresponds to the position of the longitudinal center axis 148 of the heating laser beam 142 at the first upper side 130. Consequently, the heating laser beam advancing line 158 corresponds to a trajectory of the longitudinal center axis 148 of the heating laser beam 142 moving at the first upper side 130.

A speed of advance at which the heating laser beam 142 is moved along the heating laser beam advancing line 158 is 2.4 m/min, for example.

It is provided that the machining surface 152 protrudes outwardly and/or is curved outwardly with respect to a partial region 162 of the workpiece 104. In the example shown in FIGS. 5a and 5b, the partial region 162 corresponds to the workpiece segment 154b formed after separation. The curvature of the machining surface 152 results in a bulge 164 and/or an outward protrusion on the workpiece segment 154 after separation.

Accordingly, the machining surface 152 (and the resulting separating surface 156) is assigned a preferred direction 160 (see FIGS. 5a and 6), which points from the interior of the workpiece 104 in the direction of the curvature of the machining surface 152 and/or the bulge 164. The preferred direction 160 is oriented perpendicular to a plane 166, which runs parallel to the thickness direction 134 and parallel to the advancing line 150.

The preferred direction 160 results from the direction of a distance do, oriented parallel to the normal of the plane 166, between the material modification 138a closest to the first outer side 130 and that material modification 138b which has the greatest distance to the material modification 138a parallel to the normal (see FIG. 6). Here, the material modifications 138 are considered in a cross-sectional plane oriented perpendicular to the advancing direction 126 or to the advancing line 150.

The preferred direction 160 thus corresponds to a directional component of a distance vector from the material modification 138a to the material modification 138b oriented parallel to the normal of the plane 166.

The distance d₀ between the material modifications 138a and 138b corresponds to an extension length of the machining line 136 and/or the machining surface 152 and/or the separating surface 156 in the preferred direction 160.

In particular, the material modification 138a closest to the first outer side 130 can be adjacent to the first outer side 130 and/or can penetrate the first outer side 130.

One direction of the positional offset Δd is oriented opposite and/or anti-parallel to the preferred direction 160.

The thermal subjection of the material 102 by means of the heating laser beam 142 causes the material 102 to be separated along the machining surface 152, resulting, for example, in the workpiece segments 154a and 154b shown in FIG. 5b.

In the embodiment shown in FIG. 6, the machining line 136 is formed as arcuate and in particular as a circular arc so that a correspondingly arcuate and outwardly curved machining surface 152 or separating surface 156 results.

In the embodiment according to FIG. 6, the distance d₀ between the material modifications 138a and 138b is 140 μm, for example. With a diameter d₁ of the heating laser beam of 2.7 mm, for example, the positional offset Δd is 1,000 μm.

The material 102 of the workpiece 104 is, for example, aluminum silicate glass. For example, in order to form the material modifications 138 as type III modifications, a laser beam from which the focusing elements 120 are formed then has a wavelength of 1030 nm and a pulse duration of 3 ps. Furthermore, a numerical aperture associated with the focusing optical unit 118 is then 0.4 and a pulse energy associated with a single focusing element 120 is 50 nJ to 200 nJ.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

α Angle of attack
d Distance
dₓ Effective distance component
d_{z} Effective distance component
d₀ Distance/extension length
d₁ Diameter
Δd Positional offset
D Thickness
I Intensity
x₀ Position in the x-direction
y₀ Position in the y-direction
z₀ Position in the z-direction
100 Laser system
102 Material
104 Workpiece
106 Beam splitting element
108 Input laser beam
110 Laser beam source
112 Beam cross-section
114 Wavefront
116 Sub-beams
116a Sub-beam
116b Sub-beam
118 Focusing optical unit
119 Machining laser beam
120 Focusing element
120a Focusing element
121 Focus distribution
122 Beam forming device
124 Beam propagation direction
126 Advancing direction
127 Advancing device
130 First outer side
132 Second outer side
134 Thickness direction
136 Machining line
137 Crack
138 Material modification
138a Material modification
138b Material modification
140 Section
140a First section
140b Second section
140c Third section
142 Heating laser beam
144 Further laser beam source
146 Beam cross-section
148 Longitudinal center axis
150 Advancing line
152 Machining surface
154a Workpiece segment
154b Workpiece segment
156 Separating surface
158 Heating laser beam advancing line
160 Preferred direction
162 Partial region
164 Bulge
166 Plane

1. A method for separating a workpiece, the method comprising:
providing a pulsed machining laser beam, which forms a plurality of focusing elements, wherein the workpiece comprises a material transparent to the machining laser beam,
introducing the focusing elements into the material of the workpiece, and moving the focusing elements parallel to a predetermined advancing line relative to the material, wherein material modifications, arranged by the moving the focusing elements relative to the material along a machining surface, are formed in the material, and wherein the machining surface protrudes with respect to a partial region of the workpiece in a preferred direction, and
subjecting the material to a heating laser beam, wherein the material of the workpiece is opaque to the heating laser beam,
wherein the heating laser beam is moved relative to the material along a heating laser beam advancing line, thereby separating the material along the machining surface,
wherein the heating laser beam advancing line runs parallel to the predetermined advancing line and is spaced apart from the predetermined advancing line with a positional offset that is anti-parallel to the preferred direction, and wherein the positional offset is at least 10% and at most 50% of a diameter of the heating laser beam.

2. The method according to claim 1, wherein the positional offset is at least 15% of the diameter of the heating laser beam.

3. The method according to claim 1, wherein the machining laser beam and/or the heating laser beam are coupled through a first outer side of the workpiece into the material, wherein a thickness direction of the workpiece is oriented perpendicularly to the first outer side.

4. The method according to claim 1, wherein the partial region, with respect to which the machining surface protrudes in the preferred direction, is subjected to the heating laser beam, and/or the heating laser beam advancing line runs in the partial region.

5. The method according to claim 1, wherein the preferred direction is oriented perpendicular to a plane that runs parallel to the predetermined advancing line and parallel to a thickness direction of the workpiece.

6. The method according to claim 1, wherein the machining surface extends continuously between a first outer side and a second outer side of the workpiece spaced apart from the first outer side in a thickness direction.

7. The method according to claim 1, wherein the diameter of the heating laser beam is at least 0.5 mm and at most 5 mm.

8. The method according to claim 1, wherein the machining laser beam has a wavelength of at least 300 nm and at most 1500 nm, and/or the machining laser beam has ultra-short laser pulses.

9. The method according to claim 1, wherein the heating laser beam has a wavelength of at least 9 μm and at most 11 μm.

10. The method according to claim 1, wherein the workpiece has a thickness between 10 μm and 10 mm.

11. The method according to claim 1, wherein an extension length of the machining surface oriented parallel to the preferred direction has at least 5% and at most 70% of a thickness of the workpiece.

12. The method according to claim 1, wherein the focusing elements are arranged, when viewed in a cross-section oriented perpendicularly to the predetermined advancing line and/or in a projection oriented perpendicularly to the predetermined advancing line, along a predetermined machining line, which defines a cross-sectional shape of the machining surface and/or a cross-sectional shape of a separating surface produced by the separating the material along the machining surface.

13. The method according to claim 1, wherein the focusing elements are formed by splitting an input laser beam into a plurality of sub-beams by using a beam splitter and by focusing the plurality of sub-beams coupled out from the beam splitter.

14. The method according to claim 13, wherein the splitting the input laser beam is performed by a phase imposition on a beam cross-section of the input laser beam.

15. The method according to claim 1, wherein the material modifications are accompanied by a crack formation of the material, and/or wherein the material modifications are type III material modifications.

16. A laser system for separating a workpiece, the laser system comprising:
a laser beam source, a beam splitter, and a focusing optical unit, which together are configured to provide a machining laser beam that forms a plurality of focusing elements for introduction into a material of the workpiece,
an advancing device for moving the focusing elements with respect to the material of the workpiece parallel to a predetermined advancing line in order to form material modifications arranged in the material along a machining surface, wherein the machining surface protrudes with respect to a partial region of the workpiece in a preferred direction, and
a further laser beam source for providing a heating laser beam, wherein the advancing device is configured to move the heating laser beam along a heating laser beam advancing line relative to the material in order to separate the material along the machining surface,
wherein the heating laser beam advancing line runs parallel to the predetermined advancing line and is spaced apart from the predetermined advancing line with a positional offset that is anti-parallel to the preferred direction, and wherein the positional offset is at least 10% and at most 50% of a diameter of the heating laser beam.
